(19) United States
(12) Patent Application Publication
(10) Pub. No.: US 2009/0295243 A1
(43) Pub. Date: Dec. 3, 2009

(54) METHOD FOR MOUNTING AN INNER STATOR FOR A MOTOR

(76) Inventors: Lawrence Leroy Kneisel, Novi, MI (US); Aurelian Bahmata, South Lyon, MI (US)

Correspondence Address: FRASER CLEMENS MARTIN & MILLER LLC, 28366 KENSINGTON LANE, PERRYSBURG, OH, 43551, US

(21) Appl. No.: 12/132,010

(22) Filed: Jun. 3, 2008

(51) Int. Cl. H02K 5/04; H02K 15/02; H02K 15/14; H02K 7/08

(52) U.S. Cl. 310/89; 29/596; 310/90

(57) ABSTRACT

An assembly and method for mounting a stator in an inner stator motor that facilitates insertion and removal of the stator, militates against stator rotation during motor operation and allows the stator to be securely and accurately mounted. The assembly includes a motor housing having a hollow stator post, a stator, and a fastener.

### FIELD OF THE INVENTION

The invention relates to electric motors and more particularly to methods for positioning and securing a stator in an inner stator motor.

### BACKGROUND OF THE INVENTION

Electric motors have long been used as a means to power compressors used in air conditioning systems. For simplicity and cost effectiveness, electric motors have often been incorporated within a sealed compressor housing, being known as a hermetically sealed compressor. A sealed housing containing the electric motor and the compressor is advantageous because it eliminates the need for a durable power transfer seal between the electric motor and the compressor. Generally, assembly of the hermetically sealed compressor involves press fitting an outer stator into an open end of a half of the compressor housing, fixing it in place. A compressor with an attached inner rotor is then attached to another open end of a half of the compressor housing. Assembly of the hermetically sealed compressor is finished by joining the halves of the compressor housing, aligning the stator and rotor, and welding the housing halves together, forming a finished unit.

As a result of the benefits of the aforementioned outer stator arrangement, inner stator motors have not been used in hermetically sealed compressors. Additionally, inner stator motors encounter manufacturing difficulties when incorporated into a hermetically sealed compressor. Particularly, an inner stator arrangement makes insertion and removal of the stator very difficult. This is because of the large pressing forces needed to secure the stator to a central shaft. A compressor utilizing an inner stator motor could benefit from the higher torque and better space efficiency present in inner stator motors.

It would be desirable to have a method for mounting a stator in an inner stator motor, wherein the method facilitates easy insertion and removal of the stator and allows a stator to be securely and accurately mounted while militating against stator rotation during motor operation.

### SUMMARY OF THE INVENTION

Presently provided by the invention, an apparatus and method for mounting a stator in an inner stator motor, that militates against stator rotation during motor operation, that allows a stator to be securely and accurately mounted, and facilitates easy insertion and removal of the stator has surprisingly been discovered.

In one embodiment, the assembly for an inner stator motor comprises a motor housing having an open end and a hollow stator post disposed therein, the stator post having at least one slot formed therein; a stator having a cavity and positioned on the stator post, the stator having at least one protuberance cooperating with the slot; and a fastener positioned in the stator post, the fastener exerting a radial force on the stator post and causing the stator post to expand to secure the stator to the stator post.

In another embodiment, the assembly for an inner stator motor comprises a motor housing having an open end and a hollow stator post disposed therein, the stator post having at least one slot formed therein; a stator having a cavity and positioned on the stator post, the stator having at least one protuberance cooperating with the slot; a sleeve disposed in the stator post, the sleeve adapted to engage a tool to remove the fastener from the stator post; and a fastener positioned in the stator post, the fastener exerting a radial force on the stator post and causing the stator post to expand to secure the stator to the stator post.

The invention also provides methods for mounting a stator in an inner stator motor.

In one embodiment, the method for assembling an inner stator motor comprises the steps of providing a motor housing, including a housing having an open end and a hollow stator post disposed in the housing, the stator post having at least one slot formed therein; providing a stator having a cavity, the stator having at least one protuberance to cooperate with the slot; providing a fastener; aligning protuberances of the stator with slots of the stator post; disposing the stator on the stator post; and positioning the fastener in the stator post, the fastener exerting a radial force on the stator post to cause the stator post to expand and secure the stator to the stator post.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is an exploded perspective view of an assembly for an inner stator motor including a motor housing, a stator, and a fastener.

FIG. 2 is a cross-sectional perspective view of the assembly for the inner stator motor illustrated in FIG. 1.

FIG. 3 is a cross-sectional perspective view of an assembly for an inner stator motor according to another embodiment of the invention.

FIG. 4 is a partially exploded perspective view of the assembly for the inner stator motor illustrated in FIG. 3.

### DETAILED DESCRIPTION OF EXEMPLARY EMBODIMENTS OF THE INVENTION

The following detailed description and appended drawings describe and illustrate an exemplary embodiment of the present invention. The description and drawings serve to enable one skilled in the art to make and use the invention, and are not intended to limit the scope of the invention in any manner. It is understood that materials other than those described can be used without departing from the scope and spirit of the invention. In respect of the methods disclosed, the steps presented are exemplary in nature, and thus, the order of the steps is not necessary or critical.

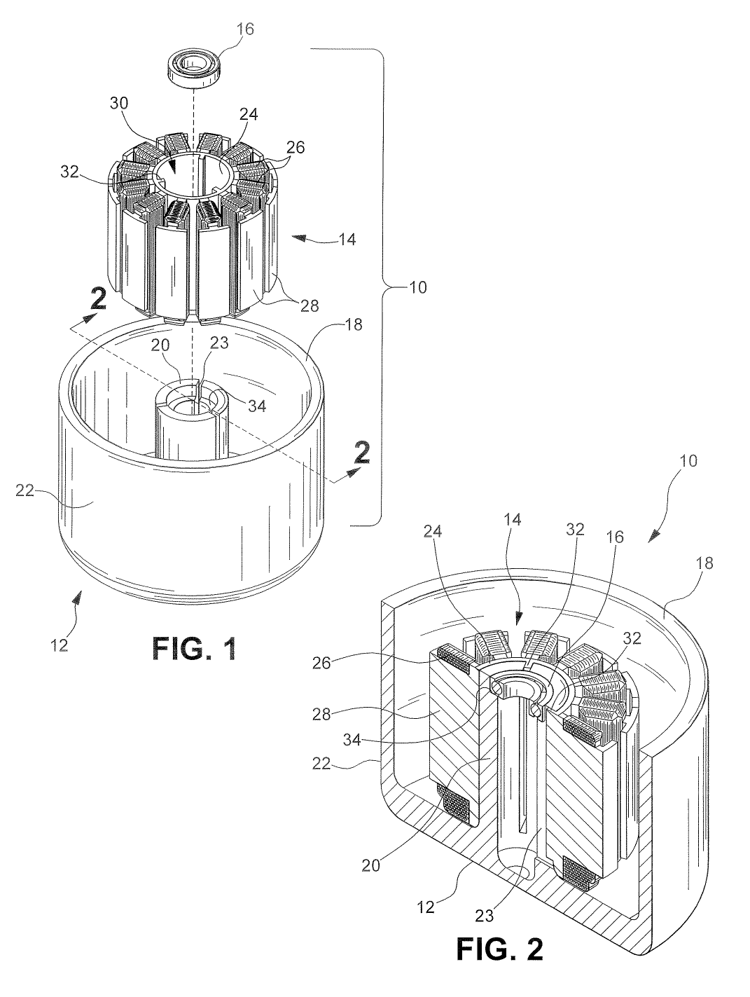

FIG. 1 shows an exploded perspective view of an assembly 10 for an inner stator motor according to an embodiment of the invention. The assembly 10 includes a motor housing 12, a stator 14, and a fastener 16. The motor housing 12, the stator 14, and the fastener 16 cooperate to form an assembly 10 for an inner stator motor. The motor housing 12 can be produced from any conventional material such as aluminum, for example. Additionally, the motor housing 12 can be manufactured through any conventional process such as casting. The motor housing 12 has an open end 18, in which the stator 14 and fastener 16 are received. A hollow stator post 20 is formed in the motor housing 12. The stator post 20 may be integrally formed with an outer wall member 22. At least one slot 23 is formed in the stator post 20. In the embodiment shown, three slots 23 are formed. The stator post 20 may be further characterized by the addition of an aperture or apertures, into which an anti-rotation device (not shown) is inserted. It is understood the assembly 10 for an inner stator motor may be coupled to a compressor housing for use in a hermetically sealed compressor for a vehicle air conditioning system.

The stator 14 includes a central hub 24 and windings 26. The central hub 24 can be produced from any conventional material such as aluminum, for example, and includes a radial array of winding heads 28. As shown, the winding heads 28 have a “T” shaped cross section, but other shapes may be used as desired. The windings 26 are disposed on the winding heads 28 in a manner needed to result in generation of magnetic forces for operating the completed electric motor. A cavity 30 in the stator receives the stator post 20. The cavity 30 has at least one protuberance 32 adapted to be received in the slot 23 to militate against a rotation of the stator 14 on the stator post 20.

The fastener 16 is adapted to be received in the stator post 20, as illustrated in FIG. 2. In the embodiment shown in FIGS. 1 and 2, the stator post 20 includes a circular seat 34 to aid in positioning the fastener 16. The fastener 16 may be a bearing ring as shown, part of a ball bearing, or other fasteners as desired. When a bearing ring is used as the fastener 16, a rotor (not shown) is coupled to the bearing, eliminating the need for a separate fastener.

FIG. 2 shows a completed assembly 10. Assembly of the components begins with the stator 14 being positioned on the stator post 20. At least one protuberance 32 cooperates with the slot 23 to align the stator 14 in the motor housing 12. Upon the stator 14 being completely seated within the motor housing 12, the fastener 16 is positioned in the stator post 20 to exert a radial force on the stator post 20. The radial force causes the stator post 20 to expand, thereby securing the stator 14.

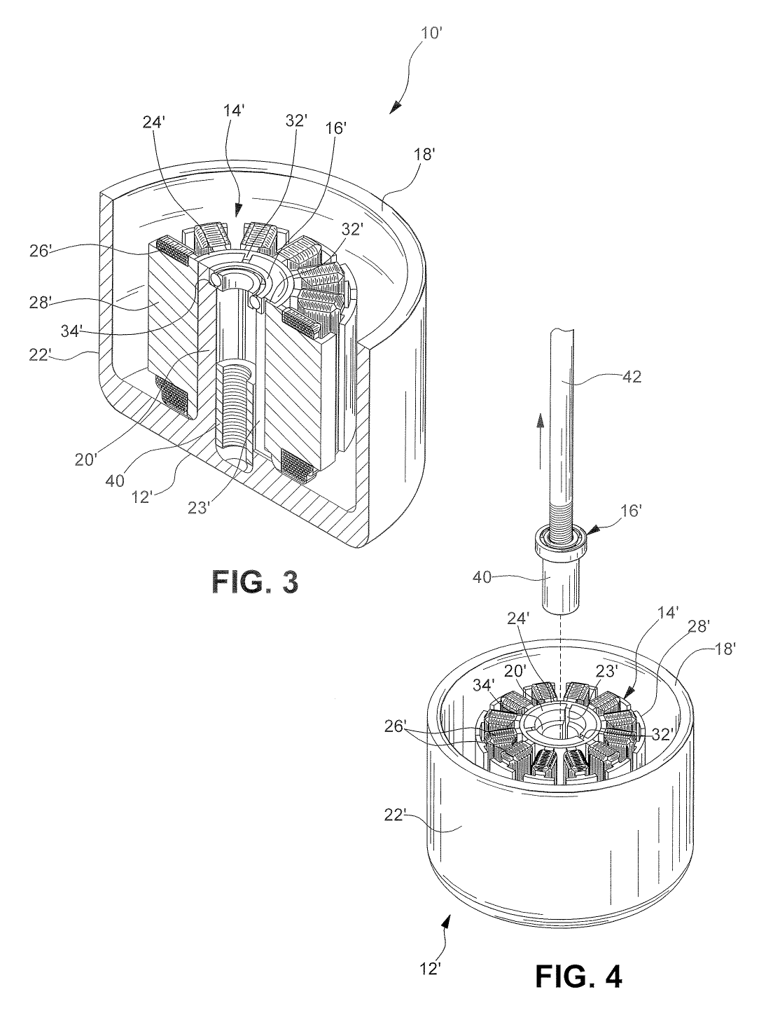

FIGS. 3 and 4 show an inner stator motor assembly 10′ according to a second embodiment of the invention. Structure repeated from the description of FIGS. 1 and 2 includes the same reference numeral and a prime (′) symbol. A threaded sleeve 40 is disposed in the stator post 20′. The sleeve 40 provides an attachment point for a fastener removal tool 42. In the embodiment shown, the sleeve 40 is press fit into the stator post 20′ after the stator 14′ is positioned on the stator post 20′ to militate against movement of the sleeve 40 during motor operation. When service of the motor is required and the stator 14′ must be removed, the fastener removal tool 42 is inserted through the fastener 16′ and engaged with the sleeve 40. A force is exerted on the fastener removal tool 42 to remove the sleeve 40 and the fastener 16′ from the stator post 20′, thereby allowing the stator 14′ to be removed from the motor housing 12′.

A method for assembling an inner stator motor incorporating the motor housing 12, the stator 14, and the fastener 16 facilitates secure and accurate mounting of the stator 14. The method may further provide a sleeve 40 disposed in the stator post 20, wherein the sleeve 40 is adapted to engage a fastener removal tool 42 for removal of the fastener 16 from the stator post 20. The method also militates against a rotation of the stator 14 during motor operation while facilitating easy insertion and removal of the stator 14, dependent on the position of the fastener 16. The method eliminates the need for a difficult mechanical pressing of the stator 14 on the stator post 20, allowing an inner stator motor to be used in a hermetically sealed compressor.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

I claim:

1. A motor housing for an inner stator motor comprising:
a housing having an open end; and
a hollow stator post disposed in said housing and having at least one axial slot formed therein.

2. A motor housing for an inner stator motor according to claim 1, wherein said stator post includes three slots formed therein.

3. A motor housing for an inner stator motor according to claim 1, wherein the motor housing is produced from aluminum.

4. A motor housing for an inner stator motor according to claim 1, wherein the motor housing is adapted to be joined with a compressor motor for a vehicle air conditioning system.

5. A motor housing for an inner stator motor according to claim 1, wherein the motor housing is formed by casting.

6. A motor housing for an inner stator motor according to claim 1, wherein said stator post is adapted to receive a sleeve.

7. An assembly for an inner stator motor comprising:
a motor housing having an open end and a hollow stator post disposed therein, the stator post having at least one slot formed therein;
a stator having a cavity formed therein and at least one protuberance formed thereon, said stator positioned on the stator post, wherein at least one protuberance is received in the slot; and
a fastener joined with the stator post, said fastener exerting a radial force on the stator post causing the stator post to expand to secure said stator to the stator post.

8. An assembly for an inner stator motor according to claim 7, wherein the stator post includes three slots formed therein.

9. An assembly for an inner stator motor according to claim 7, wherein the assembly includes a sleeve disposed in the stator post, said sleeve adapted to engage a tool to remove said fastener from the stator post.

10. An assembly for an inner stator motor according to claim 9, wherein said sleeve is a threaded sleeve disposed in the stator post by a press fit.

11. An assembly for an inner stator motor according to claim 7, wherein the inner stator motor is a compressor motor in a vehicle air conditioning system.

12. An assembly for an inner stator motor according to claim 7, wherein said fastener is a bearing ring.

13. An assembly for an inner stator motor according to claim 7, wherein said motor housing is formed by casting.

14. A method for assembling an inner stator motor comprising the steps of:
providing a motor housing having an open end and a hollow stator post disposed in the housing, the stator post having at least one slot formed therein;
providing a stator having a cavity, the stator having at least one protuberance adapted to be received in the slot;
providing a fastener;
aligning the protuberance of the stator with the slots of the stator post;
disposing the stator on the stator post; and
positioning the fastener in the stator post, the fastener exerting a radial force on the stator post to cause the stator post to expand and secure the stator to the stator post.

15. The method for assembling an inner stator motor according to claim 14, wherein the stator post includes three slots formed therein.

16. The method for assembling an inner stator motor according to claim 14, wherein the assembly includes a sleeve disposed in the stator post, the sleeve adapted to engage a tool to remove the fastener from the stator post.

17. The method for assembling an inner stator motor according to claim 16, wherein the sleeve is a threaded sleeve disposed in the stator post by a press fit.

18. The method for assembling an inner stator motor according to claim 14, wherein the inner stator motor is a compressor motor in a vehicle air conditioning system.

19. The method for assembling an inner stator motor according to claim 14, wherein the fastener is a bearing ring.

20. The method for assembling an inner stator motor according to claim 14, wherein the motor housing is formed by casting.
